(19) United States
(12) Patent Application Publication
(10) Pub. No.: US 2012/0304733 A1
(43) Pub. Date: Dec. 6, 2012

(54) LUMINESCENT WEAR SENSING

(76) Inventors: Jörg Peter Feist, London (GB); John Rayment Nicholls, Buckinghamshire (GB); Christopher Charles Pilgrim, Norfolk (GB)

(21) Appl. No.: 13/383,002

(22) PCT Filed: Jul. 8, 2010
(86) PCT No.: PCT/GB2010/001310

§ 371 Date: Aug. 27, 2012

(30) Foreign Application Priority Data
Jul. 8, 2009 (GB) 0911850.6

(51) Int. Cl. G01N 17/00; C09K 11/08

(52) U.S. Cl. 73/7; 252/301.4 R

(57) ABSTRACT

A wear-sensing structure comprising a metallic object having a wear-sensing layer at a surface which is subject to wear, wherein the wear-sensing layer comprises a host metallic matrix having a luminescent ceramic phase dispersed therewithin, the ceramic phase comprising a ceramic host containing a luminescent material which luminesces when illuminated with an illuminating radiation, with wear of the object being determined by reference to luminescence from the luminescent material.

The present invention relates to material compositions which provide for luminescent wear sensing, in particular for use in severe wear applications and when subjected to harsh and hostile environments, and structures, for example, single, multi-layer or composite coatings, which incorporate such material compositions.

Wear represents a significant failure mechanism in various equipment, in causing material loss, which eventually leads to the associated piece of equipment being shut down. Wear can be impact wear, that is, erosion or abrasion of a surface, which occurs when materials move relative to another and can be solid-on-solid or fluid-on-solid, or corrosive wear, where material loss occurs through corrosion or a surface. In general, wear occurs in almost every machine which has moving parts or is exposed to a hostile environment.

The present invention aims to provide material compositions which provide for luminescent wear sensing, in particular for use in severe wear applications and when subjected to harsh and hostile environments, and structures, for example, single, multi-layer or composite coatings, which incorporate such material compositions, and preferably confer wear resistance to the underlying object.

The present invention has numerous applications, including:

(1) Earth Moving, Transfer and Crushing

This equipment comprises machines from large-scale mining equipment and pumps to small-scale digging tools, as used in agriculture or road maintenance. Wear on critical parts can cause unpredicted plant outages, which can lead to significant financial consequences, particularly where high volumes of materials are involved, such as in the mining industry. The transfer of coal or rocks on conveyer belts can cause damage and is dependent on changing parameters. Further, heavy industrial crushing equipment used in the manufacturing of powder products is very susceptible to wear.

(2) Transportation

Large container ships or oil tankers depend on diesel engines or gas turbines for propulsion and power systems. These engines and turbines are of considerable size and have critical parts which experience wear. A particularly critical part of such engines and turbines is the power shaft, which is not usually directly accessible.

(3) Power Generation

Steam turbines are very susceptible to water droplet damage. This usually causes ‘water-droplet-erosion’ on critical components, such as the blades.

(4) Cutting/Drilling Tools

Cutting and drilling tools are used in various industries, for example, in cutting hard materials, such as rocks, concrete, metal, and in drilling oil/gas wells.

In one aspect the present invention provides a wear-sensing structure comprising a metallic object having a wear-sensing medium or layer at a surface which is subject to wear, wherein the wear-sensing medium comprises a host metallic matrix having a luminescent ceramic phase dispersed therewithin, the ceramic phase comprising a ceramic host containing a luminescent material which luminesces when illuminated with an illuminating radiation, with wear of the object being determined by reference to luminescence from the ceramic phase.

In another aspect the present invention provides a method of determining wear of the above-described structure, comprising the steps of: illuminating at least a section of the wear-sensing layer with an illuminating radiation; detecting luminescence from the wear-sensing layer; and determining wear of the structure by reference to any detected luminescence.

In a further aspect the present invention provides a method of determining wear of the above-described structure, comprising the steps of: illuminating material removed from the wear-sensing layer by wear with an illuminating radiation; detecting any luminescence from the removed material; and determining wear of the structure by reference to any detected luminescence.

In a yet further aspect the present invention provides a detection system for determining wear of a plurality of components within a common environment, comprising: a flow path which is in fluid communication with a plurality of components, which each have the above-described wear-sensing structure; and a detector for detecting luminescent material flowing through or collected in the flow path as a result of wear of the wear-sensing layers of the components; wherein the wear-sensing layers of each of the components incorporate luminescent materials having different luminescent characteristics, whereby wear of the different components is determined by the common detector by reference to the detected luminescent characteristics.

In yet another aspect the present invention provides a detection system for controlling operation of a component incorporating the above-described wear-sensing structure, comprising: a detector for detecting a luminescence signal from the wear-sensing layer and determining wear of the component from the detected luminescence; and a controller for controlling operation of at least one operating parameter of the component in response to the determined wear.

In still another aspect the present invention provides a wear-sensing composition comprising a metallic matrix material and a luminescent ceramic phase, the ceramic phase comprising a ceramic host containing a luminescent material which luminesces when illuminated with an illuminating radiation, with wear being determined by reference to luminescence from the luminescent material.

Preferred embodiments of the present invention will now be described hereinbelow by way of example only with reference to the accompanying drawings, in which:

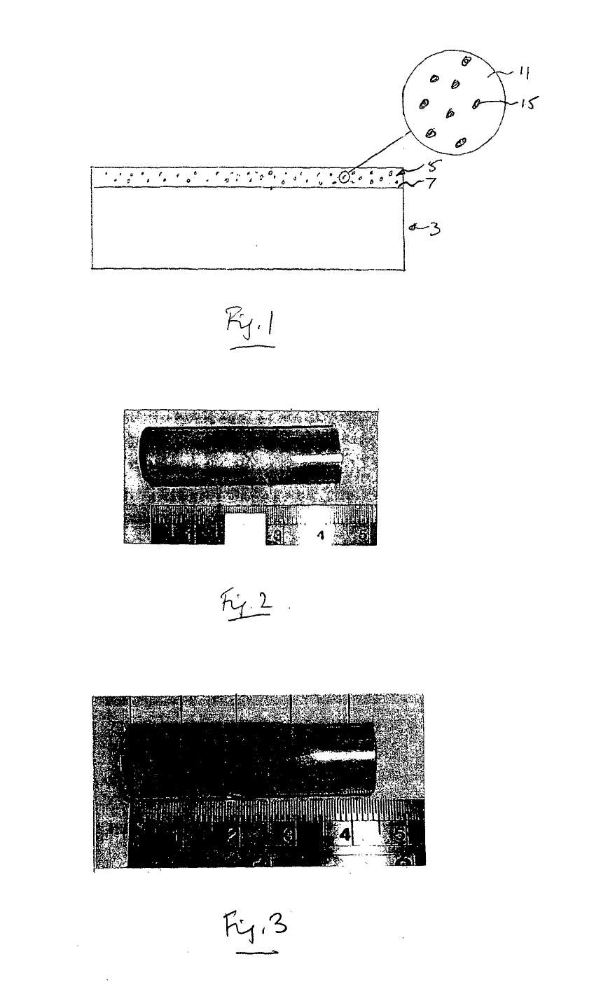

FIG. 1 schematically represents a wear-sensing structure in accordance with a first embodiment of the present invention;

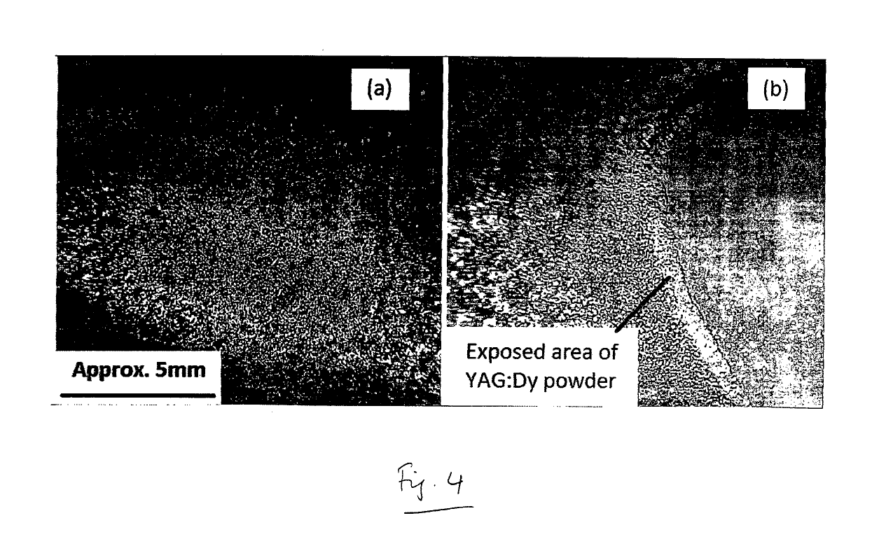

FIG. 2 illustrates a bar which is part coated with a wear-sensing layer in accordance with Sample #1 of Example #1;

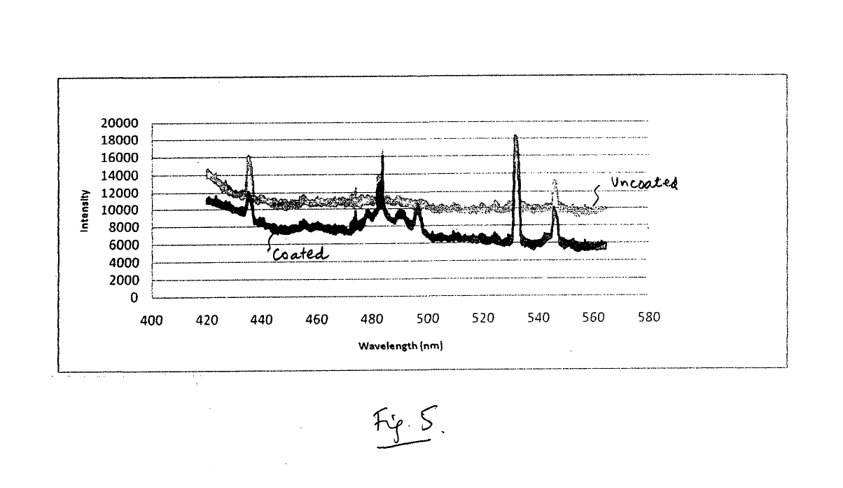

FIG. 3 illustrates a bar which is part coated with a wear-sensing layer in accordance with Sample #2 of Example #1;

FIGS. 4(a) and (b) illustrate in enlarged scale sections of the main body and the edge of the wear-sensing layer of FIG. 2, respectively;

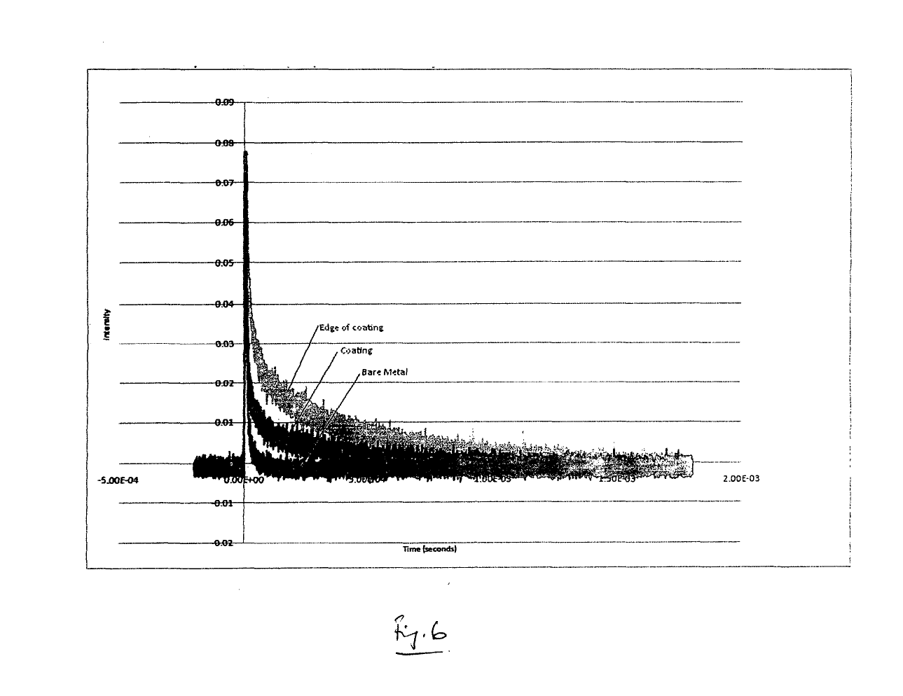

FIG. 5 illustrates emission spectra from the coated and uncoated sections of the wear-sensing layer of Sample #1 of Example #1 at an excitation wavelength of 355 nm;

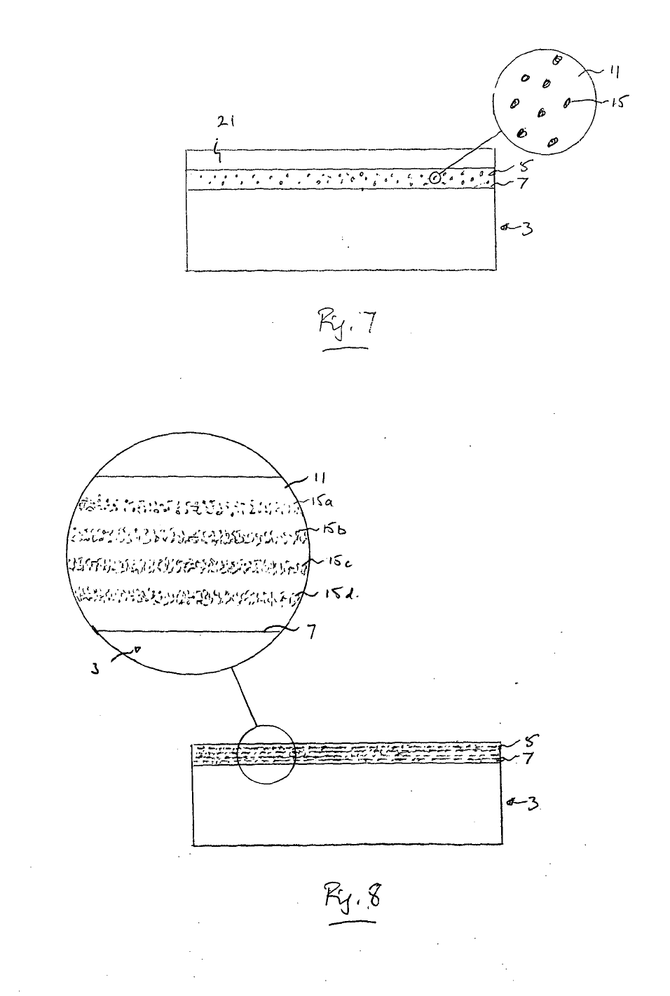

FIG. 6 illustrates measured lifetime decays for Sample #1 of Example #1 from the main body of the wear-sensing layer, the edge of the wear-sensing layer and an uncoated section at an excitation wavelength of 355 nm and a detection wavelength of 500±10 nm;

FIG. 7 schematically represents a wear-sensing structure in accordance with a second embodiment of the present invention;

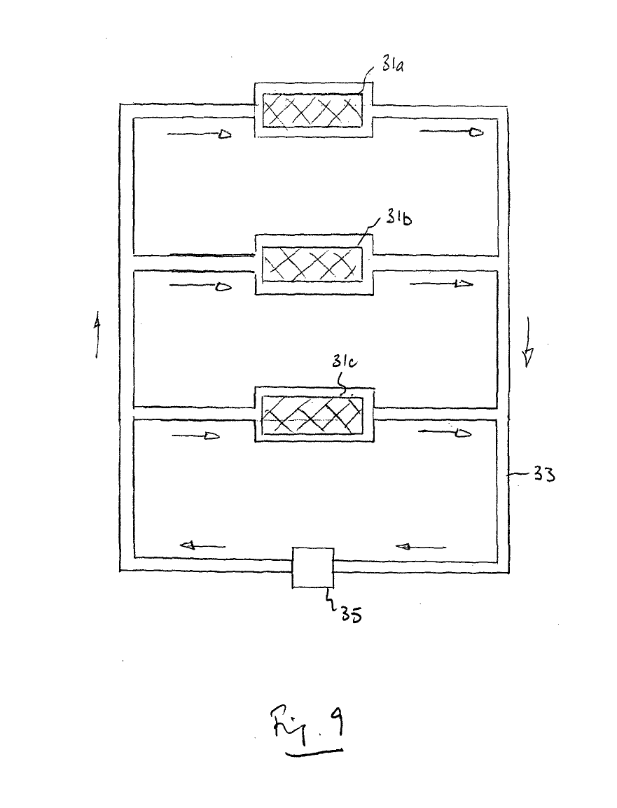

FIG. 8 schematically represents a wear-sensing structure in accordance with a third embodiment of the present invention;

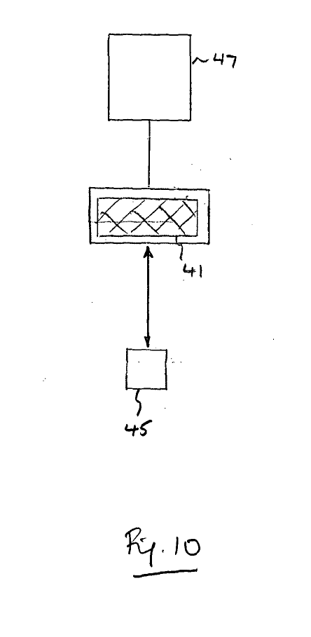

FIG. 9 illustrates a detection system in accordance with a first embodiment of the present invention; and

FIG. 10 illustrates a detection system in accordance with a second embodiment of the present invention.

FIG. 1 schematically represents a wear-sensing structure in accordance with a first embodiment of the present invention.

The wear-sensing structure comprises a metallic object 3 having a wear-sensing layer 5 at a surface 7 which is subject to wear.

In this embodiment the wear-sensing layer 5 is a coating applied to the surface 7 of the object 3. In an alternative embodiment the wear-sensing layer 5 could be integrally formed in the fabrication of the object 3.

In preferred embodiments the wear-sensing layer 5 can be manufactured by any of spin casting, hiping, ciping, spraying, dipping or weld surfacing overlay (welding).

The wear-sensing layer 5 comprises a host metallic matrix 11 having a luminescent ceramic phase 15 dispersed therewithin.

In this embodiment the metallic matrix 11 is formed of substantially the same material as the object 3.

In preferred embodiments the metallic matrix 11 comprises a metal alloy, and preferably one of the following materials:
Copper based alloys, particularly phosphor bronzes (especially Cu+18-20 wt % Sn+up to 0.25 wt % Pb+up to 0.25 wt % Fe+up to 1.0 wt % P)
Ferrous based alloys, particularly hard irons and steels (especially with 2-11 wt % Cr and 4-7 wt % Ni), chromium-molybdenum steels (especially with 11-23 wt % Cr+up to 3 wt % Mo) and high chromium steels (especially with 23-30 wt % Cr)
Nickel based alloys, particularly nickel based superalloys (especially Ni+15-30 wt % Cr+3.5-10 wt % Al+3.5-10 wt % Ti+0.1-2 wt % Zr+0.1-0.8 wt % Si, plus other additions, such as Co, Cu, Fe)
Cobalt based alloys, particularly cobalt based superalloys (especially Co+15-30 wt % Cr+1.0-3.0 wt % Si+3.0-8.0 wt % W+1.0-15 wt % Ni, plus other additions, such as B, C, N) and Stellite®

In this embodiment the ceramic phase 15 dispersion strengthens the host metallic matrix 11, thereby providing for increased wear resistance at the surface 7 of the object 3.

In preferred embodiments the ceramic phase 15 can comprise particles of regular shape, such as spherical particles, or asymmetric shape, such as laminates (micro or nano laminates), depending upon the mode of wear to be resisted.

In one embodiment the ceramic phase 15 comprises particles of at least two different shapes, such as cubic and spherical, or compositions, which allow different modes of wear to be characterized, for example, sliding wear, adhesive wear, abrasive wear, erosion, erosion-corrosion, fretting, fretting-corrosion, rolling contact fatigue, with different ones of the particles being preferentially removed by different wear mechanisms.

In preferred embodiments the ceramic phase 15 has a particle size in the range of from about 10 nm to about 100 μm.

In one embodiment the ceramic phase 15 has a particle size in the range of from about 10 nm to about 50 μm, optionally about 10 nm to about 20 μm, optionally about 100 nm to about 20 μm, and optionally about 100 nm to about 10 μm.

In another embodiment the ceramic phase 15 has a particle size in the range of from about 1 μm to about 100 μm, optionally about 10 μm to about 100 μm, optionally about 20 μm to about 100 μm, optionally about 40 μm to about 100 μm, and optionally about 40 μm to about 90 μm.

In this embodiment the wear-sensing layer 5 contains less than about 60 wt % of the ceramic phase 15, optionally less than about 40 wt %, and optionally less than about 20 wt %.

In this embodiment the wear-sensing layer 5 contains less than about 40 vol % of the ceramic phase, and optionally less than about 20 vol %.

In one embodiment the ceramic phase 15 comprises an oxide phase.

In one embodiment the ceramic phase 15 comprises a zirconia based phase.

In one embodiment the ceramic phase 15 comprises yttria stabilized zirconia (YSZ).

In another embodiment the ceramic phase 15 comprises a zirconate pyrochiore (A₂Zr₂O₇), where A is preferably one or more elements from the lanthanide series (La Lu).

In one embodiment the ceramic phase 15 comprises one of La₂Zr₂O₇, Nd₂Zr₂O₇, Sm₂Zr₂O₇ or Gd₂Zr₂O₇.

In a further embodiment the ceramic phase 15 comprises a pyrochlore (A₂B₂O₇), where A is preferably one or more elements from the lanthanide series (La→Lu) or the actinide series (Ac→Lr) and B is preferably one or more elements from the group of transition metals.

In one embodiment the ceramic phase 15 comprises La₂Ce₂O₇.

In a still further embodiment the ceramic phase 15 comprises a magnetoplumbite (AB₁₊ₓCₓAl₁₁₋₂ₓO₁₉), where A is preferably one or more elements from La→Gd, B is preferably one or more elements from Mg, Sr, and Mn→Zn, C is preferably one or more of Ti and Si, and 0<x<5.5.

In one embodiment the ceramic phase 15 comprises LaMgAl₁₁O₁₉.

In a yet further embodiment the ceramic phase 15 comprises a monazite (APO₄), where A is at least one of La, Ce, Pr, Nd, Th and Y.

In one embodiment the ceramic phase 15 comprises LaPO₄.

In still another embodiment the ceramic phase 15 comprises a garnet.

In one embodiment the ceramic phase 15 comprises an yttrium aluminum garnet (YAG) (Y₃AlₓFe₅₋ₓO₁₂), where 0<x<5, and optionally Fe can be replaced partially or entirely by one or more transition metals, including Cr.

In one embodiment the ceramic phase 15 comprises Y₃Al₅O₁₂.

In another embodiment the ceramic phase 15 comprises a gadolinium aluminum garnet (GAG) (Gd₃AlₓFe₅₋ₓO₁₂), where 0<x<5.5, and optionally Fe can be replaced partially or entirely by one or more transition metals, including Cr.

In one embodiment the ceramic phase 15 comprises Gd₃Al₅O₁₂.

In yet still another embodiment the ceramic phase 15 comprises a perovskite.

In one embodiment the ceramic phase 15 comprises an yttrium aluminum perovskite (YAP) (YAlₓFe₁₋ₓO₃), where 0<x<1, and optionally Fe can be replaced partially or entirely by one or more transition metals, including Cr.

In one embodiment the ceramic phase 15 comprises YAlO₃.

In another embodiment the ceramic phase 15 comprises a gadolinium aluminum perovskite (GAP) (GdAlₓFe₁₋ₓO₃), where 0<x<1, and optionally Fe can be replaced partially or entirely by one or more transition metals, including Cr.

In one embodiment the ceramic phase 15 comprises GdAlO₃.

In yet another embodiment the ceramic phase 15 comprises a monoclinic.

In one embodiment the ceramic phase 15 comprises a yttrium aluminum monoclinic (YAM) (Y₄AlₓFe₂₋ₓO₉), where 0≦x≦2, and optionally Fe can be replaced partially or entirely by one or more transition metals, including Cr.

In one embodiment the ceramic phase 15 comprises Y₄Al₂O₉.

In another embodiment the ceramic phase 15 comprises a gadolinium aluminum monoclinic (GAM) (Gd₃AlₓFe₂₋ₓO₉), where 0<x<2, and optionally Fe can be replaced partially or entirely by one or more transition metals, including Cr.

In one embodiment the ceramic phase 15 comprises Gd₄Al₂O₉.

In another embodiment the ceramic phase 15 comprises a nitride phase.

In one embodiment the ceramic phase 15 comprises silicon nitride (Si₃N₄: melting point at 1900° C.) or titanium nitride (TiN: melting point 2930° C.).

In a further embodiment the ceramic phase 15 comprises a carbide phase.

In one embodiment the ceramic phase 15 comprises silicon carbide (SiC: melting point 2730° C.) or tungsten carbide (WC: melting point 2870° C.).

In other embodiments the ceramic phase 15 can comprise any suitable complex metal oxide.

In this embodiment the ceramic phase 15 is a host phase which contains a luminescent material, which luminesces when illuminated with an illuminating radiation.

In this embodiment the ceramic phase 15 is selected to be thermodynamically compatible with the metallic matrix 11, but also is chemically stable, in particular in harsh environments where exposed to high temperatures and also possibly acidic fluids.

In this embodiment the ceramic phase 15 is thermally stable at temperatures exceeding 300° C., optionally exceeding 400° C., optionally exceeding 700° C., optionally exceeding 800° C., optionally exceeding 1000° C., and optionally exceeding 1200° C.

In this embodiment the ceramic phase 15 is capable of withstanding pressures of 10 bar, optionally 20 bar.

In this embodiment the luminescent material comprises one or more photo-luminescent dopant compounds selected from a group of elements including the rare earth elements (Lanthanide group: Ce, Pr, Nd, Pm, Sm, Eu, Gd, Tb, Dy, Ho, Er, Tm and Yb) and the transition metals, such as Mn and Cr. When illuminated with light, these phosphors are excited and luminesce, allowing for detection with a detector.

In this embodiment the ceramic phase 15 contains up to about 50 wt % of luminescent material, optionally less than about 20 wt %, optionally less than about 10 wt %, and optionally less than about 5 wt %.

In one embodiment the wear-sensing layer 5 can be compositionally graded to provide an increasing volume fraction of the ceramic phase 15 towards an outermost surface thereof. In one embodiment the wear-sensing layer 5 can be a multi-layer structure, where each outer layer progressively has an increased volume fraction of the ceramic phase 15.

With this configuration, wear is detected using a detection system as the wear-sensing layer 5 is removed.

In this embodiment the detection system uses a laser light source, preferably a YAG:Nd laser, to provide excitation at a wavelength of 266 nm, 355 nm or 532 nm.

In this embodiment the detection system uses a detector, such as a photomultiplier, a photodiode, a CCD camera or a photocamera to capture the luminescence.

In one mode of use, wear of a predetermined extent is detected when the wear-sensing layer 5 has been removed to the extent that substantially no luminescence signal is detected.

In another mode of use, wear is detected by detection of luminescence from the luminescent material which is collected with removal of the wear-sensing layer 5, for example, in a lubricant, coolant or exhaust gas flow, with a rate of wear being determined by the rate of collection of the luminescent material. In this mode of use, the object 3 could have the ceramic phase 15 distributed therethroughout, instead of being provided in one or more surface layers.

In one embodiment the detection system scans the wear-sensing layer 5 prior to use of the object 3 in order to identify sections which provide increased signal response, and one or more of these sections are subsequently used to characterize the wear of the object 3. Detection of a luminescence signal is particularly problematic in metals, and the present inventors have recognized that identifying sections of the wear-sensing layer 5 which provide for an increased signal-to-noise ratio is advantageous.

In one embodiment the detection system scans the wear-sensing layer 5 repeatedly during use of the object 3 in order to identify any wear patterns, particularly for localized wear, which allows a mode of wear to be identified, and the associated equipment to be shut down, preferably automatically, ahead of predicted failure. This scanning of the wear-sensing layer 5 to map the wear pattern can be particularly advantageous in identifying unexpected, and possibly catastrophic, modes of wear.

In addition to detecting wear, the luminescent ceramic phase 15 can be utilized to characterize other parameters of the operative environment of the object 3, including ageing of the object 3, which results as a consequence of operation in a high-temperature environment, and also monitoring temperature. As discussed in the applicant's earlier WO-2009/083729, the host of the luminescent phase 15 can be selected from materials which exhibit structural, crystal changes at one or more temperature boundaries, and these different crystal structures exhibit different spectral responses, thereby allowing the luminescent phase 15, and hence the metallic phase 11, to be aged. As discussed in the applicant's earlier WO-A-2000/006796, the luminescent phase 15 exhibits a spectral response which is a function of temperature, allowing temperature to be determined from the luminescence.

This embodiment of the present invention will now be described hereinbelow by reference to the following non-limiting Example.

### Example #1

In this Example, wear-sensing layers 5, comprising (Sample #1) 90 vol % Stellite 720® and 10 vol % YAG—3 mol % Dy₂O₃ and (Sample #2) 60 vol % Stellite 720® and 40 vol % YAG—3 mol % Dy₂O₃, were applied to an object 3, comprising a cylindrical bar of stainless steel (304SS).

In this Example, the YAG material was a spherical powder having a particle size distribution of from 20 μm to 90 μm.

In this Example, the wear-sensing layers 5 were applied by dip coating the objects 3 in slurries of the materials of Samples #1 and #2, and subsequently sintering.

FIG. 2 illustrates the object 3 having the wear-sensing layer 5 of Sample #1.

FIG. 3 illustrates the object 3 having the wear-sensing layer 5 of Sample #2.

As can be seen from FIGS. 2 and 3, the sintered coating of Sample #1 is a solid, integral coating, whereas the sintered coating of Sample #2 is blistered and friable, and unsuited for a wear application.

FIGS. 4(a) and (b) illustrate enlarged views of the wear-sensing layer 5 of Sample #1, with FIG. 4(a) illustrating a section of the main body of the wear-sensing layer 5 and FIG. 4(b) illustrating a section at the edge of the wear-sensing layer 5.

As will be observed, the edge of the coating has a markedly different morphology to that of the main body of the coating, as will be discussed further below.

FIG. 5 illustrates emission spectra of the coated and uncoated sections of the wear-sensing layer 5 of Sample #1 at an excitation wavelength of 355 nm.

As will be observed, Dy emission lines between 475 nm and 495 nm are present in the emission spectrum for the coated section, but absent from the emission spectrum for the uncoated section, allowing for detection of wear, as a consequence of removal of the wear-sensing layer 5.

FIG. 6 illustrates measured lifetime decays for Sample #1 from the main body of the coating, the edge of the coating and an uncoated section of the base metal at an excitation wavelength of 355 nm and a detection wavelength of 500±10 nm.

As will be observed, a characteristic lifetime decay can be determined for the coating (both within the main body and at the edge), thereby allowing for detection of removal of the coating, and hence wear, based on detection of the lifetime decay.

It will be noted that the greatest signal response and longest lifetime decay is observed from the edge of the coating.

It is thus postulated that an edge feature provides for an increased signal response, and thus, in a preferred embodiment, it is proposed to incorporate an edge feature or facet, either as a termination of the wear-sensing layer 5 or as a profile in a continuous wear-sensing layer 5.

FIG. 7 illustrates a wear-sensing structure in accordance with a second embodiment of the present invention.

The wear-sensing structure of this embodiment is quite similar to that of the first-described embodiment, and thus, in order to avoid unnecessary duplication of description, only the differences will be described in detail, with like parts being designated by like reference signs.

In this embodiment the wear-sensing structure further comprises an outer metallic layer 21 which is located over the wear-sensing layer 5.

The metallic layer 21 optically shields the wear-sensing layer 5, such that the luminescent material of the wear-sensing layer 5 is invisible to the detection system until the metallic layer 21 has been removed, at least substantially, through wear.

In this embodiment the metallic layer 21 is formed of substantially the same material as the metallic host 11 of the wear-sensing layer 5.

In use, wear of a predetermined extent is detected using the detection system when a luminescence signal is detected from the wear-sensing layer 5. In this mode of use, the object 3 could have the ceramic phase 15 distributed therethroughout, instead of being provided in one or more layers.

FIG. 8 illustrates a wear-sensing structure in accordance with a third embodiment of the present invention.

The wear-sensing structure of this embodiment is quite similar to that of the first-described embodiment, and thus, in order to avoid unnecessary duplication of description, only the differences will be described in detail, with like parts being designated by like reference signs.

In this embodiment the wear-sensing layer 5 comprises a plurality of different luminescent ceramic phases 15a-d which are arranged in bands located progressively outwards from the surface 7 of the object 3, with each of the ceramic phases 15a-d having a different luminescent characteristic, thereby enabling a characterization of the extent of wear by reference to the luminescence characteristic.

In this embodiment, with wear of the object 3 and removal of the wear-sensing layer 5, the band containing the first ceramic phase 15a is first reached, then the band containing the second ceramic phase 15b, then the band containing the third ceramic phase 15c, and finally the band containing the fourth ceramic phase 15d. Each band thus provides an indication as to the increasing level of wear, which can be represented to the user in the form of a “traffic light” representation, with the innermost band preferably representing a worn-out indication. For example, in a YAG based host, the ceramic phase 15 can be doped with different lanthanides, such as Dy (blue, green), Tb (green) and Eu (red), to provide for progressive wear indications.

In addition to characterization of the extent of wear, the rate of wear can be determined by reference to the spacing between the bands of the different ceramic phases 15a-d.

In this embodiment the bands of the different ceramic phases 15a-d are separated by bands of the metallic host 11, such that there is a distinct transition and no optical overlap between the detected luminescence from the different ceramic phases 15a-d. In an alternative embodiment the adjacent bands of the different ceramic phases 15a-d could be juxtaposed, or indeed partially overlapping, such that, as the luminescence signal from one ceramic phase 15a-d is declining, the luminescence signal from the adjacent ceramic phase 15a-d is increasing.

In an alternative embodiment the innermost ceramic phase 15d could be distributed throughout the object 3, instead of being applied in a separate layer.

FIG. 9 illustrates a detection system in accordance with a first embodiment of the present invention.

The detection system comprises a flow path 33 which is in fluid communication with a plurality of components 31a-c, typically within a single machine, which each have the wear-sensing structure of one of the above-described embodiments, and a detector 35 for detecting luminescent material flowing through or collected in the flow path 33 as a result of wear of the wear-sensing layers 5 of the components 31a-c.

In this embodiment the flow path 33 forms part of a lubrication network by which the components 31a-c are lubricated. In alternative embodiments the flow path 33 could form part of a coolant network by which the components 31a-c are cooled, or part of an exhaust flow through which exhaust gases are directed.

In this embodiment the wear-sensing layers 5 of each of the components 31a-c incorporate luminescent materials having different luminescent characteristics, such as to enable characterization of the wear of the different components 31a-c by the common detector 35. In this way, the wear of the various components 31a-c can be commonly monitored on-line, without any invasive testing.

FIG. 10 illustrates a detection system in accordance with a second embodiment of the present invention.

The detection system comprises a component 41 which has the wear-sensing structure of one of the above-described embodiments, a detector 45 for detecting a luminescence signal from the wear-sensing layer 5, and a controller 47 for controlling operation of the component 41 in response to the detected luminescence.

In this embodiment the component 41 comprises a cutter, such as drill, which requires a lubricant and/or coolant and can be operated at varying speeds and pressures. In this embodiment, by detecting the wear of the component 41, the rate of lubricant and/or coolant delivery and the cutter speed and pressure can be controlled to provide for optimal cutting, which can vary depending upon the medium being cut, such as in drilling oil/gas wells, and also it is possible to predict failure and thereby prevent such a failure from occurring.

Finally, it will be understood that the present invention has been described in its preferred embodiments and can be modified in many different ways without departing from the scope of the present invention as defined by the appended claims.

1. A wear-sensing structure comprising a metallic object having a wear-sensing layer at a surface which is subject to wear, wherein the wear-sensing layer comprises a host metallic matrix having a luminescent ceramic phase dispersed therewithin, the ceramic phase comprising a ceramic host containing a luminescent material which luminesces when illuminated with an illuminating radiation, with wear of the object being determined by reference to luminescence from the ceramic phase, optionally the luminescent material comprises one or more photo-luminescent dopant compounds selected from a group of elements including the rare earth elements (Lanthanide group: Ce, Pr, Nd, Pm, Sm, Eu, Gd, Tb, Dy, Ho, Er, Tm and Yb) and the transition metals, such as Mn and Cr.

2. The structure of claim 1, wherein the wear-sensing layer is a coating applied to the surface of the object or integrally formed in the fabrication of the object.

3. (canceled)

4. The structure of claim 1, wherein the metallic matrix is formed of substantially the same material as the object.

5. The structure of claim 1, wherein the metallic matrix comprises a metal alloy, optionally the metallic matrix comprises (1) a copper based alloy, optionally a phosphor bronze, (2) a ferrous based alloy, optionally a hard iron or steel, a chromium-molybdenum steel or a high chromium steel, (3) a nickel based alloy, optionally a nickel based superalloy, or (4) a cobalt based alloy, optionally a cobalt based superalloy or Stellite®.

6. (canceled)

7. (canceled)

8. (canceled)

9. (canceled)

10. The structure of claim 1, wherein the ceramic phase dispersion strengthens the host metallic matrix, thereby providing for increased wear resistance at the surface of the object.

11. The structure of claim 1, wherein the ceramic phase comprises (1) particles of regular shape, optionally spherical particles, or (2) particles of asymmetric shape, optionally laminates (micro or nano laminates).

12. (canceled)

13. The structure of claim 1, wherein the ceramic phase comprises particles of at least two different shapes or compositions, with different ones of the particles being preferentially removed by different wear mechanisms and thereby allowing characterization of the wear mechanism.

14. The structure of claim 1, wherein the ceramic phase has a particle size in the range of from about 10 nm to about 100 μm, optionally (1) the ceramic phase has a particle size in the range of from about 10 nm to about 50 μm, optionally about 10 nm to about 20 μm, optionally about 100 nm to about 20 μm, and optionally about 100 nm to about 10 μm or (2) the ceramic phase has a particle size in the range of from about 1 μm to about 100 μm, optionally about 10 μm to about 100 μm, optionally about 20 μm to about 100 μm, optionally about 40 μm to about 100 μm, and optionally about 40 μm to about 90 μm.

15. (canceled)

16. (canceled)

17. The structure of claim 1, wherein the wear-sensing layer contains less than about 60 wt % of the ceramic phase, optionally less than about 40 wt %, and optionally less than about 20 wt %.

18. (canceled)

19. The structure of claim 1, wherein the ceramic phase comprises (1) an oxide phase, optionally the ceramic phase comprises a zirconia based phase, optionally (i) yttria stabilized zirconia (YSZ), (ii) a zirconate pyrochlore (A₂Zr₂O₇), where A is preferably one or more elements from the lanthanide series (La→Lu), (iii) La₂Zr₂O₇, (iv) Nd₂Zr₂O₇, (v) Sm₂Zr₂O₇ or (vi) Gd₂Zr₂O₇, optionally the ceramic phase comprises a pyrochlore (A₂B₂O₇), where A is preferably one or more elements from the lanthanide series (La→Lu) or the actinide series (Ac→Lr) and B is preferably one or more elements from the group of transition metals, optionally La₂Ce₂O₇, optionally the ceramic phase comprises a magnetoplumbite (AB₁₊ₓCₓAl₁₁₋₂ₓO₁₉), where A is preferably one or more elements from La→Gd, B is preferably one or more elements from Mg, Sr, and Mn→Zn, C is preferably one or more of Ti and Si, and 0<x<5.5, optionally LaMgAl₁₁O₁₉, optionally the ceramic phase comprises a monazite (APO₄), where A is at least one of La, Ce, Pr, Nd, Th and Y, optionally LaPO₄, the ceramic phase comprises a garnet, optionally (i) an yttrium aluminum garnet (YAG) (Y₃AlₓFe₅₋ₓO₁₂), where 0<x<5, and optionally Fe can be replaced partially or entirely by one or more transition metals, including Cr, preferably Y₃Al₅O₁₂, or (ii) a gadolinium aluminum garnet (GAG) (Gd₃AlₓFe₅₋ₓO₁₂), where 0<x<5.5, and optionally Fe can be replaced partially or entirely by one or more transition metals, including Cr, preferably Gd₃Al₅O₁₂, optionally the ceramic phase comprises a perovskite, optionally (i) an yttrium aluminum perovskite (YAP) (YAlₓFe₁₋ₓO₃), where 0<x<1, and optionally Fe can be replaced partially or entirely by one or more transition metals, including Cr, preferably YAlO₃, (ii) a gadolinium aluminum perovskite (GAP) (GdAlₓFe₁₋ₓO₃), where 0<x<1, and optionally Fe can be replaced partially or entirely by one or more transition metals, including Cr, preferably GdAlO₃, optionally the ceramic phase comprises a monoclinic, optionally (i) an yttrium aluminum monoclinic (YAM) (Y₄AlₓFe₂₋ₓO₉), where 0<x<2, and optionally Fe can be replaced partially or entirely by one or more transition metals, including Cr, preferably Y₄Al₂O₉, or (ii) a gadolinium aluminum monoclinic (GAM) (Gd₃AlₓFe₂O₉), where 0<x<2, and optionally Fe can be replaced partially or entirely by one or more transition metals, including Cr, preferably Gd₄Al₂O₉, (2) a nitride phase, optionally the ceramic phase comprises silicon nitride (Si₃N₄) or titanium nitride (TiN), or (3) a carbide phase, optionally the ceramic phase comprises silicon carbide (SiC) or tungsten carbide (WC).

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. The structure of claim 1, wherein the ceramic phase is thermally stable at temperatures exceeding 400° C., optionally exceeding 800° C., optionally exceeding 1000° C., and optionally exceeding 1200° C., and/or capable of withstanding pressures of 10 bar, optionally 20 bar.

32. (canceled)

33. (canceled)

34. The structure of claim 1, wherein the ceramic phase contains up to about 50 wt % of luminescent material, optionally less than about 20 wt %, optionally less than about 10 wt %, and optionally less than about 5 wt %.

35. The structure of claim 1, wherein the wear-sensing layer is compositionally graded to provide an increasing volume fraction of the ceramic phase towards an outermost surface thereof, optionally the wear-sensing layer is a multi-layer structure, where each outer layer progressively has an increased volume fraction of the ceramic phase.

36. The structure of claim 1, wherein wear of a predetermined extent is determined (1) when the wear-sensing layer has been removed to the extent that substantially no luminescence signal is detected or (2) by detection of luminescence from the luminescent material which is removed with wear of the wear-sensing layer.

37. (canceled)

38. The structure of claim 1, wherein the wear-sensing layer includes an edge feature or facet, optionally as a termination of the wear-sensing layer or as a profile in a continuous wear-sensing layer, from which luminescence is detected.

39. The structure of claim 1, further comprising an outer metallic layer which is located over the wear-sensing layer, optionally the metallic layer optically shields the wear-sensing layer, and wear of a predetermined extent is determined when a luminescence signal is detected from the wear-sensing layer, optionally the metallic layer is formed of substantially the same material as the metallic host of the wear-sensing layer.

40. (canceled)

41. (canceled)

42. The structure of claim 1, wherein the wear-sensing layer comprises a plurality of different luminescent ceramic phases which are arranged in bands located progressively outwards from the surface of the object, with each of the ceramic phases having a different luminescent characteristic, thereby enabling a characterization of the extent of wear by reference to the luminescence characteristic, optionally a rate of wear is determined by reference to spacings between the bands of the different ceramic phases, optionally (1) the bands of the different ceramic phases are separated by bands of the metallic host or (2) the adjacent bands of the different ceramic phases are juxtaposed or partially overlapping.

43. (canceled)

44. (canceled)

45. (canceled)

46. A method of determining wear of the structure of claim 1, comprising the steps of:
illuminating at least a section of the wear-sensing layer with an illuminating radiation, optionally the illumination is provided by a laser light source, preferably a YAG:Nd laser, and preferably providing excitation at a wavelength of 266 nm, 355 nm or 532 nm;
detecting luminescence from the wear-sensing layer; and
determining wear of the structure by reference to any detected luminescence.

47. The method of claim 46, wherein (1) wear of a predetermined extent is determined when the wear-sensing layer has been removed to the extent that substantially no luminescence signal is detected, (2) wear of a predetermined extent is determined when a luminescence signal is detected from the wear-sensing layer, following wear of an outer metallic layer, or (3) the wear-sensing layer comprises a plurality of different luminescent ceramic phases which are arranged in bands located progressively outwards from the surface of the object, with each of the ceramic phases having a different luminescent characteristic, and an extent of wear is determined by reference to the detected luminescence characteristic, optionally a rate of wear is determined by reference to spacings between the bands of the different ceramic phases.

48. (canceled)

49. (canceled)

50. (canceled)

51. The method of claim 46, wherein the ceramic phase comprises particles of at least two different shapes or compositions, with different ones of the particles being preferentially removed by different wear mechanisms, and the wear determining step comprises the step of:
characterizing a wear mechanism by reference to the luminescence from the particles of different shapes or compositions.

52. The method of claim 46, wherein the wear-sensing layer includes an edge feature or facet, optionally as a termination of the wear-sensing layer or as a profile in a continuous wear-sensing layer, and the detecting step comprises the step of:
detecting luminescence from the edge feature or facet of the wear-sensing layer.

53. The method of claim 46, further comprising the step of:
(1) scanning the wear-sensing layer prior to use of the object to identify sections which provide increased signal response; and the illuminating step comprises the step of: illuminating one or more of the identified sections of the wear-sensing layer; and the detecting step comprises the step of: detecting luminescence from the one or more of the identified sections of the wear-sensing layer; or
(2) scanning the wear-sensing layer repeatedly during use of the object to identify wear patterns, particularly for localized wear, and the wear determining step comprises the step of: characterizing a mode of wear from an identified wear pattern.

54. (canceled)

55. (canceled)

56. The method of claim 46, further comprising the step of:
determining ageing of the structure from the detected luminescence; and/or
determining temperature of the structure from the detected luminescence.

57. (canceled)

58. A method of determining wear of the structure of claim 1, comprising the steps of:
illuminating material removed from the wear-sensing layer by wear with an illuminating radiation; and
detecting any luminescence from the removed material; and
determining wear of the structure by reference to any detected luminescence; optionally wear of a predetermined extent is determined by detection of luminescence from the removed material, the illumination is provided by a laser light source, preferably a YAG:Nd laser, and preferably providing excitation at a wavelength of 266 nm, 355 nm or 532 nm, and optionally further comprising the step of:
determining ageing of the structure from the detected luminescence.

59. (canceled)

60. (canceled)

61. (canceled)

62. A detection system for determining wear of a plurality of components within a common environment, comprising:
a flow path which is in fluid communication with a plurality of components, optionally the components are part of a single machine, which each have the wear-sensing structure of claim 1; and
a detector for detecting luminescent material flowing through or collected in the flow path as a result of wear of the wear-sensing layers of the components;
wherein the wear-sensing layers of each of the components incorporate luminescent materials having different luminescent characteristics, whereby wear of the different components is determined by the common detector by reference to the detected luminescent characteristics.

63. (canceled)

64. The system of claim 62, wherein the flow path forms part of (1) a lubrication network by which the components are lubricated, (2) a coolant network by which the components are cooled, or (3) an exhaust flow through which exhaust gases are directed.

65. (canceled)

66. (canceled)

67. A detection system for controlling operation of a component incorporating the wear-sensing structure of claim 1, comprising:
a detector for detecting a luminescence signal from the wear-sensing layer and determining wear of the component from the detected luminescence; and
a controller for controlling operation of at least one operating parameter of the component in response to the determined wear;
optionally the component comprises a cutter, preferably a drill, which is operable at varying speeds and pressures, and the controller controls the speed and/or pressure of the cutter in response to the determined wear, optionally the cutter is supplied with lubricant and/or coolant, and the cutter controls a rate of lubricant and/or coolant delivery in response to the determined wear.

68. (canceled)

69. (canceled)

70. A wear-sensing composition comprising a metallic matrix material and a luminescent ceramic phase, the ceramic phase comprising a ceramic host containing a luminescent material which luminesces when illuminated with an illuminating radiation, with wear being determined by reference to luminescence from the luminescent material.
